(19) United States
(12) Patent Application Publication
(10) Pub. No.: US 2026/0231128 A1
(43) Pub. Date: Aug. 6, 2026

(54) FREQUENCY DOMAIN RESOURCE ALLOCATION FOR SINGLE DOWNLINK CONTROL INFORMATION-BASED MULTI-CELL SCHEDULING

(71) Applicant: APPLE INC., Cupertino, CA (US)

(72) Inventors: Ankit Bhamri, Bad Nauheim (DE); Wei Zeng, San Diego, CA (US); Haitong Sun, Cupertino, CA (US); Dawei Zhang, Saratoga, CA (US); Chunxuan Ye, San Diego, CA (US)

(21) Appl. No.: 19/147,201

(22) PCT Filed: Feb. 2, 2024
(86) PCT No.: PCT/US2024/014142

§ 371 Date: Jul. 10, 2025

Related U.S. Application Data
(60) Provisional application No. 63/485,379, filed on Feb. 16, 2023.

(51) Int. Cl. H04W 72/0453; H04W 72/232

(52) U.S. Cl. CPC H04W 72/0453; H04W 72/232

(57) ABSTRACT

Systems and methods for frequency domain resource allocation (RA) for single downlink control information (DCI)-based multi-cell scheduling are disclosed herein. In some embodiments, a user equipment (UE) selects a resource block group (RBG) size from a definition for a plurality of RBG sizes with respect to bandwidth part (BWP) sizes and numbers of scheduled cells. In some embodiments, the UE is configured with one or more scaling factors to apply to a nominal RBG size selected from a configured set of RBG sizes defined in terms of BWP sizes. In some cases, individual bits in frequency domain resource allocation (FDRA) field(s) in a DCI are understood to represent the determined RBG size. In some cases, resource indicator (RIV) values of FDRA field(s) are interpreted in terms of the determined RBG size. Embodiments for configuring one of multiple RA types for use between the UE and a network are also discussed.

### TECHNICAL FIELD

This application relates generally to wireless communication systems, including wireless communications systems implementing the use of single downlink control information (DCI) to schedule communications on more than one serving cell of a user equipment (UE).

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and Institute of Electrical and Electronics Engineers (IEEE) 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

Frequency bands for 5G NR may be separated into two or more different frequency ranges. For example, Frequency Range 1 (FR1) may include frequency bands operating in sub-6 gigahertz (GHz) frequencies, some of which are bands that may be used by previous standards, and may potentially be extended to cover new spectrum offerings from 410 megahertz (MHz) to 7125 MHz. Frequency Range 2 (FR2) may include frequency bands from 24.25 GHz to 52.6 GHz. Note that in some systems, FR2 may also include frequency bands from 52.6 GHz to 71 GHz (or beyond). Bands in the millimeter wave (mmWave) range of FR2 may have smaller coverage but potentially higher available bandwidth than bands in FR1. Skilled persons will recognize these frequency ranges, which are provided by way of example, may change from time to time or from region to region.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a table defining a plurality of RBG sizes with respect to BWP sizes 104 and numbers of scheduled cells, according to embodiments herein.

FIG. 2 illustrates a table defining each of a plurality of first RBG sizes and a plurality of second RBG sizes with respect to BWP sizes and numbers of scheduled cells, according to embodiments herein.

FIG. 3 illustrates a table defining a plurality of RBG sizes with respect to BWP size and numbers of scheduled cells, according to embodiments herein.

FIG. 4 illustrates a method of a UE, according to embodiments herein.

FIG. 5 illustrates a method of a UE, according to embodiments herein.

FIG. 6 illustrates a method of a UE, according to embodiments herein.

FIG. 7 illustrates a method of a UE, according to embodiments herein.

FIG. 8 illustrates a method of a UE, according to embodiments herein.

FIG. 9 illustrates a method of a RAN, according to embodiments herein.

FIG. 10 illustrates a method of a RAN, according to embodiments herein.

FIG. 11 illustrates a method of a RAN, according to embodiments herein.

FIG. 12 illustrates a method of a RAN, according to embodiments herein.

FIG. 13 illustrates a method of a RAN, according to embodiments herein.

FIG. 14 illustrates an example architecture of a wireless communication system, according to embodiments disclosed herein.

FIG. 15 illustrates a system for performing signaling between a wireless device and a network device, according to embodiments disclosed herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

Various multi-carrier enhancements as related to particularly multi-cell scheduling by single DCI may be considered. For example it may be that a network can perform multi-cell physical uplink shared channel (PUSCH)/physical downlink control channel (PDSCH) scheduling (e.g., one PDSCH/PUSCH per cell) at/for a UE with/through the use of a single DCI having the scheduling information for the multiple cells. In such circumstances, it may be beneficial to identify/define a maximum number of cells that can be scheduled simultaneously. It may also be beneficial to consider cases of both intra-band and inter-band carrier aggregation (CA) operation. It may also be beneficial to consider cases related to either/both of FR1/FR2. It may also be beneficial to optimize the (single) DCI for cases of scheduling three or more cells under such multi-cell PUSCH/PDSCH scheduling embodiments.

In some cases, with respect to field design of the (single) DCI format (which may be a format 0_X and/or a format 1_X) which schedules more than one cell, there may be various types of DCI fields. For example, a Type-1 field may use a single field. Such a type-1 field may be broken into various sub-types. In a Type-1A field, a single field indicating common information to all the co-scheduled cells may be used. In a Type-1B field, a single field indicating separate information for each of co-scheduled cells via joint indication may be used. In a Type-1C field, a single field indicating information of only one of the co-scheduled cells may be used.

As another example, a Type-2 field may use separate fields for each of the co-scheduled cells.

As another example, a Type-3 field may use either common or separate fields for each of the co-scheduled cells, or separately provide for multiple sub-groups of the co-scheduled cells, either a single common field or multiple separate fields per sub-group, depending on an explicit configuration. In some embodiments, a Type-3 field may be a field type that is optionally configurable as either a Type-1 field or a Type-2 field, as these have been described.

In some wireless communications systems, it may be that a maximum number of co-scheduled cells by a DCI format 1_X is four. Further, in some wireless communications systems, it may be that a maximum number of co-scheduled cells by a DCI format 0_X is four.

For the DCI format 0_X/1_X, it may be that a frequency domain resource allocation (FDRA) field is a Type-2 field. In such cases, it may be beneficial to further consider the use of a larger resource block group (RBG) granularity than, e.g., that which may be an otherwise specified maximum for a wireless communication system and/or which is otherwise provided as a configured value for resource allocation (RA) type 0 (e.g., for non-co-scheduling cases).

It may also be beneficial to consider the use of a large-RBG-based resource indicator value (RIV) for RA type 1 based on understood configurable granularities for a DCI format 1_2.

It may be that an FDRA field for single-DCI multi-cell scheduling with DCI format 0_X and/or/1_X for PUSCH and/or PDSCH scheduling according to Type 2 fields (e.g., separate FDRA fields corresponding to each of the scheduled cells are used). Accordingly, discussion here relates to solutions that optimize an FDRA signaling framework with respect to minimizing overhead, while still providing the flexibility in terms of achievable frequency domain RAs. This may be done by considering, respectively, how to handle RBG granularity for RA type 0 and RBG-based RIV granularity for RA type 1.

Note that references herein to RA type 0 and RA type 1 refer to the general case of these RA types as they are defined for, for example, a 3GPP NR communication system. Accordingly, references to RA type 0 as used herein may be understood to refer more generally to cases where a bitmap provides bits explicitly indicating the configured frequency domain resources in an FDRA field. Further, references herein to RA type 1 as used herein may be understood to refer more generally to cases where a FDRA field provides an RIV that is used by the UE with configured formula(s) to identify allocated frequency domain recourses. This note is intended to provide clarification with respect to the use of this terminology herein, in view of the understanding that communications systems other than 3GPP NR communication systems (e.g., 3GPP LTE communications systems) may define these mechanisms as other than “RA type 0” and/or “RA type 1.” Where there is confusion/conflict due to such a difference, the generalized interpretations for “RA type 0” and “RA type 1” as described here should be understood to apply.

### Embodiments for a First Proposal

According to a first proposal, for single DCI-based multi-cell scheduling (for PDSCH and/or PUSCH), the UE may be configured by the network with a set of RBG sizes.

In a first alternative for the first proposal, the nominal RBG size to use for scheduling in the frequency domain is determined corresponding to the number of resource blocks (RBs) in an active BWP of a cell and the number of actual scheduled cells.

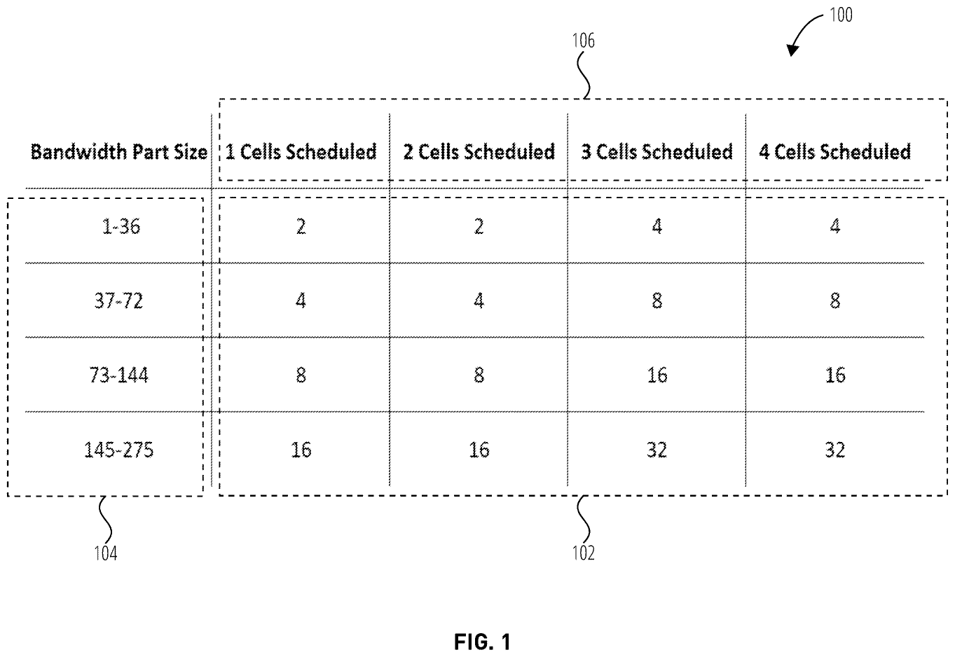

FIG. 1 illustrates a table 100 defining a plurality of RBG sizes 102 with respect to bandwidth part (BWP) sizes 104 and numbers of scheduled cells 106, according to embodiments herein. As illustrated, the table indicates that in cases where a BWP has one to 36 resource blocks, these RBs are scheduled in granularities of RBGs having two RBs in the case that one cell is scheduled by the DCI, in granularities of RBGs having two RBs in the case that two cells are scheduled by the DCI, in granularities of RBGs having four RBs in the case that three cells are scheduled by the DCI, and in granularities of RBGs having four RBs in the case that four cells are scheduled by the DCI. Further, in cases where a BWP has 37 to 72 resource blocks, these RBs are scheduled in granularities of RBGs having four RBs in the case that one cell is scheduled by the DCI, in granularities of RBGs having four RBs in the case that two cells are scheduled by the DCI, in granularities of RBGs having eight RBs in the case that three cells are scheduled by the DCI, and in granularities of RBGs having eight RBs in the case that four cells are scheduled by the DCI. Further, in cases where a BWP has 73 to 144 resource blocks, these RBs are scheduled in granularities of RBGs having eight RBs in the case that one cell is scheduled by the DCI, in granularities of RBGs having eight RBs in the case that two cells are scheduled by the DCI, in granularities of RBGs having 16 RBs in the case that three cells are scheduled by the DCI, and in granularities of RBGs having 16 RBs in the case that four cells are scheduled by the DCI. Finally, in cases where a BWP has 145 to 275 resource blocks, these RBs are scheduled in granularities of RBGs having 16 RBs in the case that one cell is scheduled by the DCI, in granularities of RBGs having 16 RBs in the case that two cells are scheduled by the DCI, in granularities of RBGs having 32 RBs in the case that three cells are scheduled by the DCI, and in granularities of RBGs having 32 RBs in the case that four cells are scheduled by the DCI.

The table 100 may be received at the UE in configuration information sent to the UE by the network, thereby informing the UE of the table 100 for use. With the table 100, when a (single) DCI that schedules communication between the UE and the network on one or more scheduled cells arrives at the UE, the UE may determine the BWP size that applies at a cell using a BWP index in the DCI as applied to a pre-configured table of BWPs for that cell. Then, the UE is enabled, based on the number of cells scheduled by the DCI and the active BWP size for the cell, to identify the RBG size (in RBs) from the table 100 that is represented by each bit of an FDRA field in the DCI for that cell according to the RA type 0 mechanism. The UE can then understand the RA on each cell in the frequency domain on the indicated BWP based on the bitmap from the FDRA field for the cell as interpreted with each bit representing that RBG size, and can use that RA in the frequency domain to communicate with the network on the cell. This process may be repeated for all/each of the one or more cells.

Note that the network may accordingly use its understanding of the table 100 that it has/will send to the UE to analogously set and/or generate the bits in the FDRA fields of the DCI in order to represent, to the UE, the frequency domain resources that it is scheduling for the communications between the UE and the network. The network may, in such cases, accordingly be understood to determine the bits of the bitmap for the FDRA fields for the one or more cells in terms of granularities of the corresponding RBG size for the cell for the number of scheduled cells and the active BWP size on the cell as these are indicated by the DCI for the UE.

Note also that the particular values for the table 100 are given in FIG. 1 by way of example and not by way of limitation. Values/value ranges for one or more of BWP sizes, numbers of scheduled cells, and/or corresponding RBG sizes may be understood to be set to various different possible values according to a desired behavior of the wireless communication system.

In a second alternative for the first proposal, for single DCI-based multi-cell scheduling (for PDSCH as well as PUSCH), the UE may be configured by the network with multiple sets of RBG sizes, where each such set of RBG sizes is defined in terms of a number of RBs in the active BWP and a number of actual scheduled cells. Then, the network may indicate to the UE in DCI which of the multiple sets to use, as well as a BWP index for use in identifying BWP sizes and the number of scheduled cells.

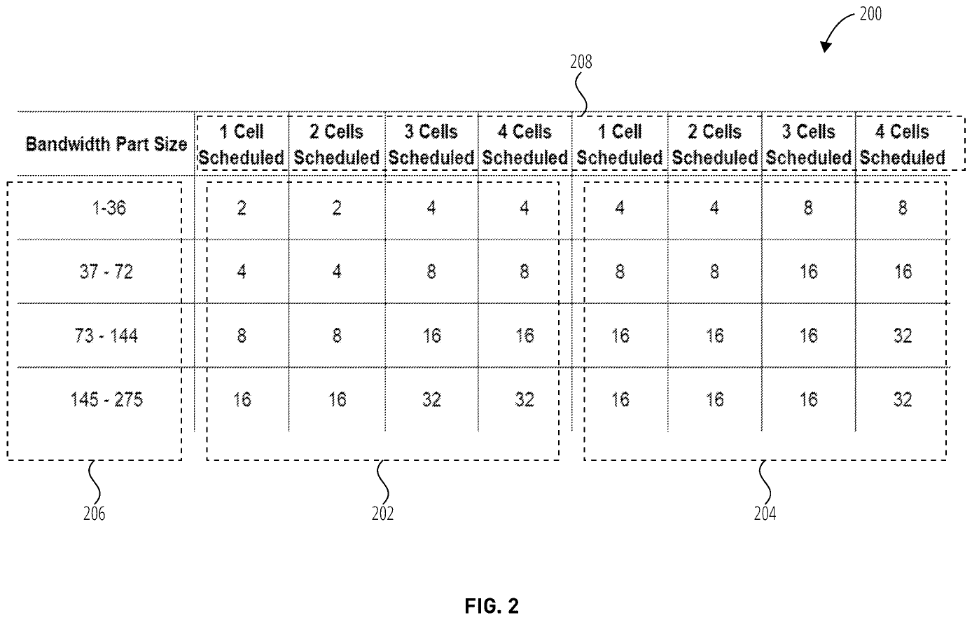

FIG. 2 illustrates a table 200 defining each of a plurality of first RBG sizes 202 and a plurality of second RBG sizes 204 with respect to BWP sizes 206 and numbers of scheduled cells 208, according to embodiments herein. As illustrated, the table 200 indicates that in cases corresponding to the first RBG sizes 202 where a BWP has one to 36 resource blocks, these RBs are scheduled in granularities of RBGs having two RBs in the case that one cell is scheduled by the DCI, in granularities of RBGs having two RBs in the case that two cells are scheduled by the DCI, in granularities of RBGs having four RBs in the case that three cells are scheduled by the DCI, and in granularities of RBGs having four RBs in the case that four cells are scheduled by the DCI. Further, in cases corresponding to the first RBG sizes 202 where a BWP has 37 to 72 resource blocks, these RBs are scheduled in granularities of RBGs having four RBs in the case that one cell is scheduled by the DCI, in granularities of RBGs having four RBs in the case that two cells are scheduled by the DCI, in granularities of RBGs having eight RBs in the case that three cells are scheduled by the DCI, and in granularities of RBGs having eight RBs in the case that four cells are scheduled by the DCI. Further, in cases corresponding to the first RBG sizes 202 where a BWP has 73 to 144 resource blocks, these RBs are scheduled in granularities of RBGs having eight RBs in the case that one cell is scheduled by the DCI, in granularities of RBGs having eight RBs in the case that two cells are scheduled by the DCI, in granularities of RBGs having 16 RBs in the case that three cells are scheduled by the DCI, and in granularities of RBGs having 16 RBs in the case that four cells are scheduled by the DCI. Finally, in cases corresponding to the first RBG sizes 202 where a BWP has 145 to 275 resource blocks, these RBs are scheduled in granularities of RBGs having 16 RBs in the case that one cell is scheduled by the DCI, in granularities of RBGs having 16 RBs in the case that two cells are scheduled by the DCI, in granularities of RBGs having 32 RBs in the case that three cells are scheduled by the DCI, and in granularities of RBGs having 32 RBs in the case that four cells are scheduled by the DCI.

The table 200 further indicates that in cases corresponding to the second RBG sizes 204 where a BWP has one to 36 resource blocks, these RBs are scheduled in granularities of RBGs having four RBs in the case that one cell is scheduled by the DCI, in granularities of RBGs having four RBs in the case that two cells are scheduled by the DCI, in granularities of RBGs having eight RBs in the case that three cells are scheduled by the DCI, and in granularities of RBGs having eight RBs in the case that four cells are scheduled by the DCI. Further, in cases corresponding to the second RBG sizes 204 where a BWP has 37 to 72 resource blocks, these RBs are scheduled in granularities of RBGs having eight RBs in the case that one cell is scheduled by the DCI, in granularities of RBGs having eight RBs in the case that two cells are scheduled by the DCI, in granularities of RBGs having 16 RBs in the case that three cells are scheduled by the DCI, and in granularities of RBGs having 16 RBs in the case that four cells are scheduled by the DCI. Further, in cases corresponding to the second RBG sizes 204 where a BWP has 73 to 144 resource blocks, these RBs are scheduled in granularities of RBGs having 16 RBs in the case that one cell is scheduled by the DCI, in granularities of RBGs having 16 RBs in the case that two cells are scheduled by the DCI, in granularities of RBGs having 16 RBs in the case that three cells are scheduled by the DCI, and in granularities of RBGs having 32 RBs in the case that four cells are scheduled by the DCI. Finally, in cases corresponding to the second RBG sizes 204 where a BWP has 145 to 275 resource blocks, these RBs are scheduled in granularities of RBGs having 16 RBs in the case that one cell is scheduled by the DCI, in granularities of RBGs having 16 RBs in the case that two cells are scheduled by the DCI, in granularities of RBGs having 16 RBs in the case that three cells are scheduled by the DCI, and in granularities of RBGs having 32 RBs in the case that four cells are scheduled by the DCI.

The table 200 may be received at the UE in configuration information sent to the UE by the network, thereby informing the UE of the table 200 for use. With the table 200, in response to a DCI scheduling one or more cells, the UE may first select which of the first RBG sizes 202 and the second RBG sizes 204 to use. This selection may be based on a radio resource control (RRC) message sent to the UE by the network that indicated which of the first RBG sizes 202 and the second RBG sizes 204 to use.

Alternatively, the one of the first RBG sizes 202 and the second RBG sizes 204 to use may be indicated implicitly to the UE based on a type of the DCI.

Once the one of the first RBG sizes 202 and the second RBG sizes 204 is selected for use, the UE identifies, for each of the one or more cells, based on the number of cells scheduled by the DCI and the BWP size for that cell as determined with respect to a BWP index in the DCI, an RBG size (in RBs) from the table 200 (and using the selected one of the first RBG sizes 202 and the second RBG sizes 204) that is represented by each bit of an FDRA field in the DCI for that cell according to the RA type 0 mechanism. The UE can then understand the RA in the frequency domain on the BWP of the cell based on the bitmap as interpreted with each bit representing that RBG size, and can use that RA in the frequency domain to communicate with the network on the cell. This process may be repeated for all/each of the one or more cells.

Note that the network may accordingly use its understanding of the table 200 that it has/will send to the UE to analogously set and/or generate the bits in the FDRA fields of the DCI in order to represent, to the UE, the frequency domain resources that it is scheduling for the communications between the UE and the network. The network may, in such cases, accordingly be understood to determine the bits of the bitmap for the FDRA fields for the one or more cells in terms of granularities of the corresponding RBG size for the cell for the number of scheduled cells that and the active BWP size on the cell as these are indicated by the DCI for the UE. The network also accordingly indicates the one of the first RBG sizes 202 and the second RBG sizes 204 to use, either using, for example, RRC messaging or implicitly through the selection of the particular format for the DCI.

Note also that the particular values for the table 100 are given in FIG. 1 by way of example and not by way of limitation. Values/value ranges for one or more of BWP sizes, numbers of scheduled cells, and/or corresponding RBG sizes may be understood to be set to various different possible values according to a desired behavior of the wireless communication system.

Further, while FIG. 2 expressly contemplates the use of two sets of RBG sizes (the first RBG sizes 202 and the second RBG sizes 204), this is given by way of example and not by way of limitation. It will be understood that a system analogous to that described in relation to FIG. 2 may support any number of sets RBG sizes greater than two.

In a third alternative for the first proposal, for single DCI-based multi-cell scheduling (for PDSCH as well as PUSCH), the UE can be configured by the network with a set of RBG sizes, wherein the nominal RBG size for a cell is determined based on a BWP size for the cell and a number of scheduled cells, and where cases of a number of scheduled cells are divided between cases where only one cell is scheduled and cases where more than one cell is scheduled.

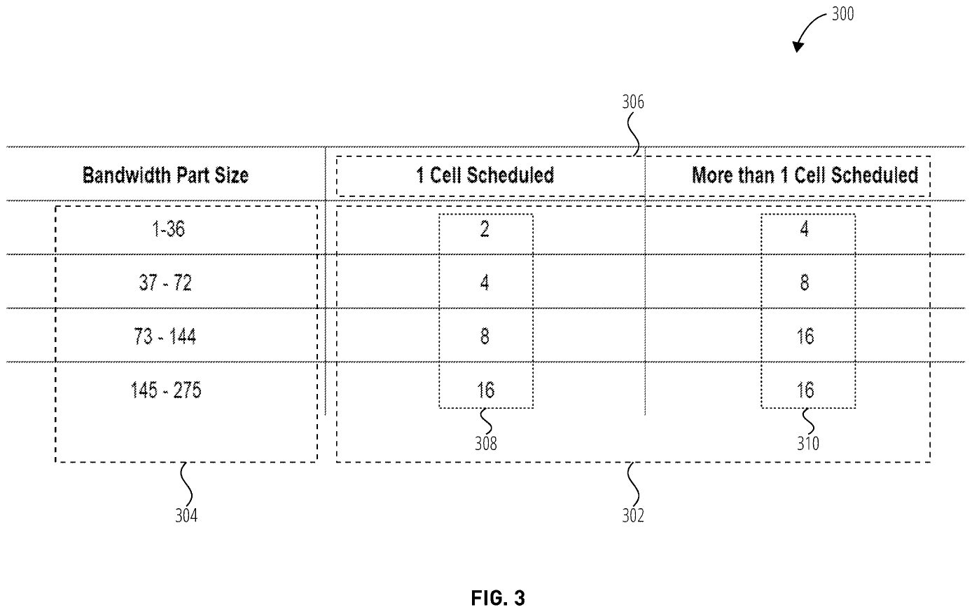

FIG. 3 illustrates a table 300 defining a plurality of RBG sizes 302 with respect to BWP size 304 and numbers of scheduled cells 306, according to embodiments herein. As illustrated, the table indicates that in cases where a BWP has one to 36 resource blocks, these RBs are scheduled in granularities of RBGs having two RBs in the case that one cell is scheduled by the DCI and in granularities of RBGs having four RBs in the case that more than one cell is scheduled by the DCI. Further, in cases where a BWP has 37 to 72 resource blocks, these RBs are scheduled in granularities of RBGs having four RBs in the case that one cell is scheduled by the DCI and in granularities of RBGs having eight RBs in the case that more than one cell is scheduled by the DCI. Further, in cases where a BWP has 73 to 144 resource blocks, these RBs are scheduled in granularities of RBGs having eight RBs in the case that one cell is scheduled by the DCI and in granularities of RBGs having 16 RBs in the case that more than one cell is scheduled by the DCI. Finally, in cases where a BWP has 145 to 275 resource blocks, these RBs are scheduled in granularities of RBGs having 16 RBs in the case that one cell is scheduled by the DCI, and in granularities of RBGs having 16 RBs in the case that more than one cell is scheduled by the DCI.

Accordingly, it may be understood that a first subset 308 for the RBG sizes 302 is used when a number of scheduled cells is one, and that a first subset 310 of the RBG sizes 302 is used when a number of scheduled cells is more than one.

The table 300 may be received at the UE in configuration information sent to the UE by the network, thereby informing the UE of the table 100 for use. With the table 100, when a (single) DCI that schedules communication between the UE and the network on one or more scheduled cells arrives at the UE, the UE may determine the BWP size that applies at a cell using a BWP index in the DCI as applied to a pre-configured table of BWPs for that cell. Then, the UE is enabled, based on the number of cells scheduled by the DCI and the active BWP size for the cell, to identify the RBG size (in RBs) from the table 100 that is represented by each bit of an FDRA field in the DCI for that cell according to the RA type 0 mechanism. The UE can then understand the RA on each cell in the frequency domain on the indicated BWP based on the bitmap from the FDRA field for the cell as interpreted with each bit representing that RBG size, and can use that RA in the frequency domain to communicate with the network on the cell. This process may be repeated for all/each of the one or more cells.

Note that the network may accordingly use its understanding of the table 100 that it has/will send to the UE to analogously set and/or generate the bits in the FDRA fields of the DCI in order to represent, to the UE, the frequency domain resources that it is scheduling for the communications between the UE and the network. The network may, in such cases, accordingly be understood to determine the bits of the bitmap for the FDRA fields for the one or more cells in terms of granularities of the corresponding RBG size for the cell for the number of scheduled cells and the active BWP size on the cell as these are indicated by the DCI for the UE.

Note also that the particular values for the table 300 are given in FIG. 3 by way of example and not by way of limitation. Values/value ranges for one or more of BWP sizes, numbers of scheduled cells, and/or corresponding RBG sizes may be understood to be set to various different possible values according to a desired behavior of the wireless communication system.

### Embodiments for a Second Proposal

According to a second proposal, a UE may be configured by the network with one set of RBG sizes corresponding to different bandwidth part sizes, where that one set is nominally used with respect to both DCIs that perform single cell scheduling and for single DCI-based multi-cell scheduling (for PDSCH as well as PUSCH). In such cases, the UE can be additionally configured and/or indicated with one or more scaling factors. Then, the UE can determine a scaled RBG size for use at each of one or more scheduled cells by multiplying the RBG size for a cell as determined using the (one) set of RBG sizes by one of the one or more scaling factors. In some embodiments, the selection of whether to use a scaling factor, and/or which of multiple scaling factors to use, may be determined based on a number of cells scheduled by the DCI, as will be described below. Note that it is anticipated that in some cases, a scaling factor of 1 may be used.

Embodiments for the use of the second proposal are now described. In a first alternative under the second proposal, only one scaling factor is configured/indicated for use multi-cell scheduling, and this (same) scaling factor is applied regardless of the number of actually scheduled cells (e.g., whether one or any number of more than once cells are scheduled). This first alternative may support multiple variations. In a first variation, one such scaling factor is configured/indicated to the UE and is used for all sets of cells used/usable by the UE. In another variation, independent such scaling factors can be configured specifically for each one of the sets of cells used/usable by the UE.

Configuration information sent to the UE by the network may include the scaling factor, thereby informing the scaling factor to the UE for use. Upon receiving DCI scheduling one or more cells for use, the UE may determine a nominal RBG size for a cell by applying the BWP size for the cell (e.g., as determined based on a BWP index provided in DCI) with the corresponding set of RBG sizes. Then, the UE may multiply the nominal RBG size for the cell with the scaling factor to generate the scaled RBG size (in RBs) for the cell that is represented by each bit of an FDRA field in the DCI for that cell according to the RA type 0 mechanism. The UE can then understand the RA in the frequency domain on the BWP of the cell based on the bitmap as interpreted with each bit representing that scaled RBG size, and can use that RA in the frequency domain to communicate with the network on the cell. This process may be repeated for all/each of the one or more cells.

Note that the network may accordingly use its understanding of the scaling factor has/will send to the UE to analogously set and/or generate the bits in the FDRA field of the DCI in order to represent, to the UE, the frequency domain resources that it is scheduling for the communications between the UE and the network. The network may, in such cases, accordingly be understood to determine the bits of the bitmap for this RA on the BWPs of the cells in granularities of the scaled RBG size for each cell.

In a second alternative under the second proposal, only one scaling factor is configured/indicated, and is used for the case of multi-cell scheduling (e.g., the scaling factor is applied to the nominal RBG size when the number of actually scheduled cells is more than one). Otherwise, the nominal RBG size is used.

Configuration information sent to the UE by the network may include the scaling factor, thereby informing the scaling factor to the UE for use. Upon receiving DCI scheduling one or more cells for use, the UE may determine a nominal RBG size for a cell by applying the BWP size for the cell (e.g., as determined based on a BWP index provided in DCI) with the corresponding set of RBG sizes. Then, if the number of actually scheduled cells is more than one, the UE may multiply the nominal RBG size for the cell with the scaling factor to generate the scaled RBG size (in RBs) for the cell that is represented by each bit of an FDRA field in the DCI for that cell according to the RA type 0 mechanism. The UE can then understand the RA in the frequency domain on the BWP of the cell based on the bitmap as interpreted with each bit representing that scaled RBG size for the cell, and can use that RA in the frequency domain to communicate with the network on the cell. This process may be repeated for all/each of the one or more cells. Note that if the number of actually scheduled cells is equal to 1, no such scaling is used (e.g., the nominal RBG size for the cell is used to interpret bits of the FDRA field instead).

Note that the network may accordingly use its understanding of the scaling factor has/will send to the UE and the number of cells it will schedule with a DCI to analogously set and/or generate the bits in the FDRA field of the DCI in order to represent, to the UE, the frequency domain resources that it is scheduling for the communications between the UE and the network. The network may, in such cases, accordingly be understood to determine the bits of the bitmap for this RA on the BWPs for each cell in granularities of the scaled RBG size or the nominal RBG size for the cell, as applicable.

In a third alternative under the second proposal, a plurality of scaling factors is configured/indicated for multi-cell scheduling cases. Then, one scaling factor from the different scaling factors can be selected for application with the nominal RBG size depending on the number of actually scheduled cells. For example, scaling factors of two, three and four may be indicated to the UE, where the scaling factor of two is used in cases where the number of actually scheduled cells by the DCI is two, the scaling factor of three is used in cases where the number of actually scheduled cells by the DCI is three, and the scaling factor of four is used in cases where the number of actually scheduled cells by the DCI is four. Note that this arrangement is given by way of example and not by way of limitation.

Configuration information sent to the UE by the network may include the scaling factors, thereby informing the scaling factors to the UE for use. Upon receiving DCI scheduling one or more cells for use, the UE may determine a nominal RBG size for a cell by applying the BWP size for the cell (e.g., as determined based on a BWP index provided in DCI) with the corresponding set of RBG sizes. Then, the UE may multiply the nominal RBG size for the cell with the one of the scaling factors that corresponds to the number of actually scheduled cells in the DCI in order to generate the scaled RBG size (in RBs) for the cell that is represented by each bit of an FDRA field in the DCI for that cell according to the RA type 0 mechanism. The UE can then understand the RA in the frequency domain on the BWP of the cell based on the bitmap as interpreted with each bit representing that scaled RBG size, and can use that RA in the frequency domain to communicate with the network on the cell. This process may be repeated for all/each of the one or more cells.

Note that the network may accordingly use its understanding of the scaling factors it has/will send to the UE and the number of cells it will schedule with a DCI to analogously set and/or generate the bits in the FDRA fields of the DCI in order to represent, to the UE, the frequency domain resources that it is scheduling for the communications between the UE and the network. The network may, in such cases, accordingly be understood to determine the bits of the bitmap for this RA in each BWP for each cell in granularities of the scaled RBG size for that cell as determined by applying the appropriate scaling factor from the set of scaling factors that corresponds to the number of scheduled cells.

### Embodiments for a Third Proposal

According to a third proposal, for single DCI-based multi-cell scheduling (for PDSCH as well as PUSCH), a same RA type can be configured/indicated to the UE for all the scheduled cells within a set of cells. In other words, the network may configure/indicate to the UE that scheduling information for all scheduled cells uses either RA type 0 or RA type 1.

In some embodiments of the third proposal, RRC messaging is used to inform the UE that the scheduling information for the scheduled cells uses either RA type 0 or RA type 1.

In some embodiments of the third proposal, a dynamic indication for the RA type that is applicable may be used. In such cases, a common bit in DCI can be used to indicate the RA type used for the scheduling, while separate bits (or bitfields) for FDRA are used respective to each of the one or more scheduled cells. The use of the common indication means that there is no need for individual indications corresponding to each of the FDRA bits/bitfields, thereby relatively reducing signaling overhead in the DCI.

### Embodiments for a Fourth Proposal

A fourth proposal for single DCI-based multi-cell scheduling (for PDSCH as well as PUSCH) relates to the use the case of RA type 1 between the UE and the network.

In some embodiments of the fourth proposal, RIVs for one or more scheduled cells are calculated at the network using formulas translating a desired frequency domain RA in a cell to an RIV that uses an RBG size for the cell determined corresponding to the first proposal discussed herein (e.g., the mechanisms described in relation to the table 100 of FIG. 1, the table 200 of FIG. 2, and/or the table 300 of FIG. 3). This correspondingly means that, at the UE side, RBG sizes to use in formulas translating the provided RIVs in the FDRA fields to frequency domain RAs may be determined based on the corresponding one of the or more of the mechanisms for determining an RBG size for a cell that have been described herein in relation to the first proposal (e.g., the mechanisms described in relation to the table 100 of FIG. 1, the table 200 of FIG. 2, and/or the table 300 of FIG. 3).

In other embodiments under the fourth proposal, RIVs for one or more scheduled cells are calculated at the network using formulas translating a desired frequency domain RA in a cell to an RIV that use a scaled RBG size determined according to an applicable scaling factor as applied to an applicable nominal RBG size from within a set of RBG sizes that is based on a BWP size being scheduled at that cell (e.g., as determined using mechanisms described in relation to the second proposal). This correspondingly means that, at the UE side, an RBG size to use in formulas translating a provided RIV in an FDRA field for a cell to a frequency domain RA for the cell may be determined based on, e.g., the use of that same scaling factor as applied to the nominal RBG size for the cell as selected from the set of RBG sizes based on the scheduled BWP size at the cell (e.g., as has been described herein in relation to the second proposal).

In other embodiments under the fourth proposal, RIVs are calculated based on the number of RBs rather than using an RBG size.

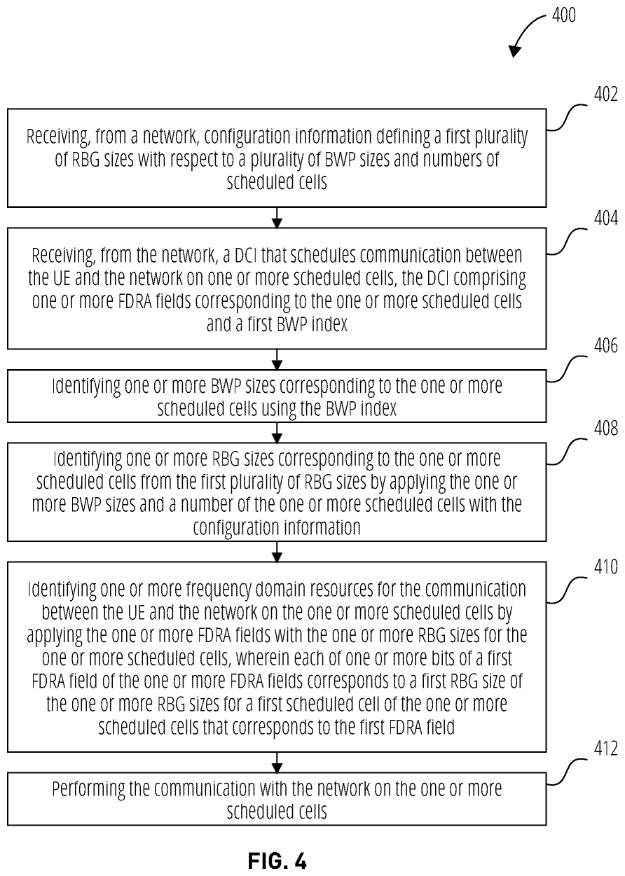

FIG. 4 illustrates a method 400, of a UE, according to embodiments herein. The method 400 includes receiving 402, from a network, configuration information defining a first plurality of RBG sizes with respect to a plurality of BWP sizes and numbers of scheduled cells.

The method 400 further includes receiving 404, from the network, a DCI that schedules communication between the UE and the network on one or more scheduled cells, the DCI comprising one or more FDRA fields corresponding to the one or more scheduled cells and a first BWP index.

The method 400 further includes identifying 406 one or more BWP sizes corresponding to the one or more scheduled cells using the BWP index.

The method 400 further includes identifying 408 one or more RBG sizes corresponding to the one or more scheduled cells from the first plurality of RBG sizes by applying the one or more BWP sizes and a number of the one or more scheduled cells with the configuration information.

The method 400 further includes identifying 410 one or more frequency domain resources for the communication between the UE and the network on the one or more scheduled cells by applying the one or more FDRA fields with the one or more RBG sizes for the one or more scheduled cells, wherein each of one or more bits of a first FDRA field of the one or more FDRA fields corresponds to a first RBG size of the one or more RBG sizes for a first scheduled cell of the one or more scheduled cells that corresponds to the first FDRA field.

The method 400 further includes performing 412 the communication with the network on the one or more scheduled cells.

In some embodiments of the method 400, the configuration information further defines a second plurality of RBG sizes with respect to the plurality of BWP sizes and the numbers of scheduled cells, and the method 400 further includes selecting, from among the first plurality of RBG sizes and the second plurality of RBG sizes, to use the first plurality of RBG sizes to identify the first RBG size. In some such embodiments, the selecting to use the first plurality of RBG sizes to determine the first one or more RBG sizes is based on one of: data of an RRC message; and a type of the DCI.

In some embodiments of the method 400, the configuration information defines that a first subset of the first plurality of RBG sizes applies when a single cell is scheduled by the DCI and that a second subset of the first plurality of RBG sizes applies when any more than one cell is scheduled by the DCI.

In some embodiments of the method 400, the DCI further comprises an indication of the number of the one or more scheduled cells.

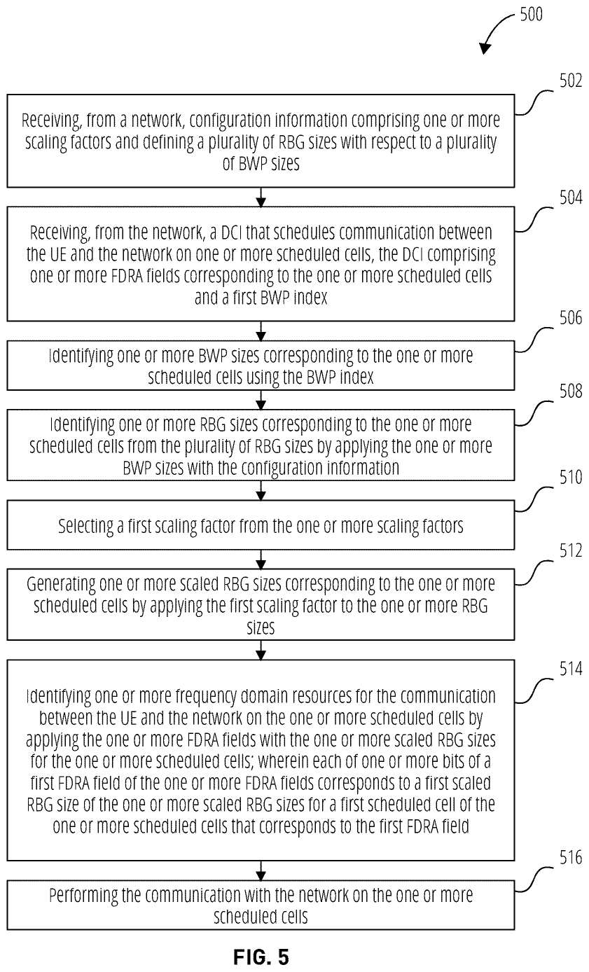

FIG. 5 illustrates a method 500 of a UE, according to embodiments herein. The method 500 includes receiving 502, from a network, configuration information comprising one or more scaling factors and defining a plurality of RBG sizes with respect to a plurality of BWP sizes.

The method 500 further includes receiving 504, from the network, a DCI that schedules communication between the UE and the network on one or more scheduled cells, the DCI comprising one or more FDRA fields corresponding to the one or more scheduled cells and a first BWP index.

The method 500 further includes identifying 506 one or more BWP sizes corresponding to the one or more scheduled cells using the BWP index.

The method 500 further includes identifying 508 one or more RBG sizes corresponding to the one or more scheduled cells from the plurality of RBG sizes by applying the one or more BWP sizes with the configuration information.

The method 500 further includes selecting 510 a first scaling factor from the one or more scaling factors.

The method 500 further includes generating 512 one or more scaled RBG sizes corresponding to the one or more scheduled cells by applying the first scaling factor to the one or more RBG sizes.

The method 500 further includes identifying 514 one or more frequency domain resources for the communication between the UE and the network on the one or more scheduled cells by applying the one or more FDRA fields with the one or more scaled RBG sizes for the one or more scheduled cells; wherein each of one or more bits of a first FDRA field of the one or more FDRA fields corresponds to a first scaled RBG size of the one or more scaled RBG sizes for a first scheduled cell of the one or more scheduled cells that corresponds to the first FDRA field.

The method 500 further includes performing 516 the communication with the network on the one or more scheduled cells.

In some embodiments of the method 500, the selecting the first scaling factor from the one or more scaling factors includes identifying that the one or more scheduled cells belongs to a configured cell set that corresponds to the first scaling factor.

In some embodiments, the method 500 further includes determining that a number of the one or more scheduled cells is greater than one, and the selecting the first scaling factor from the one or more scaling factors occurs in response to the determining that the number of the one or more scheduled cells is greater than one.

In some embodiments of the method 500, the one or more scaling factors includes a plurality of scaling factors, and the selecting the first scaling factor from the one or more scaling factors is based on a number of the one or more scheduled cells.

In some embodiments of the method 500, the DCI further comprises an indication of a number of the one or more scheduled cells.

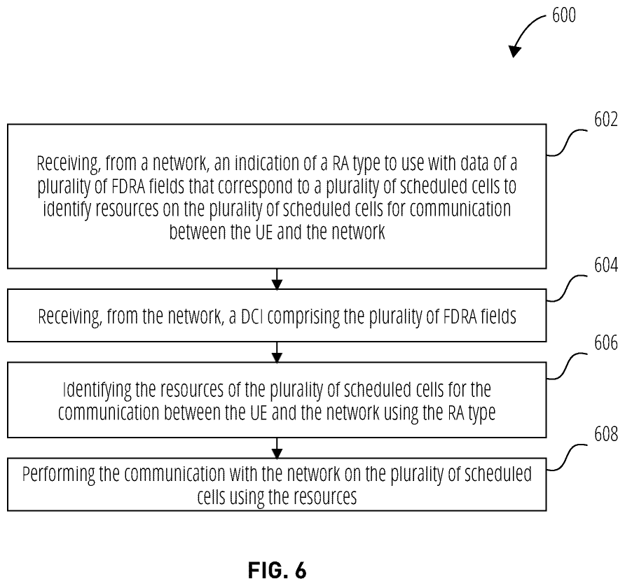

FIG. 6 illustrates a method 600 of a UE, according to embodiments herein. The method 600 includes receiving 602, from a network, an indication of a RA type to use with data of a plurality of FDRA fields that correspond to a plurality of scheduled cells to identify resources on the plurality of scheduled cells for communication between the UE and the network.

The method 600 further includes receiving 604, from the network, a DCI comprising the plurality of FDRA fields.

The method 600 further includes identifying 606 the resources of the plurality of scheduled cells for the communication between the UE and the network using the RA type.

The method 600 further includes performing 608 the communication with the network on the plurality of scheduled cells using the resources.

In some embodiments of the method 600, the indication of the RA type is received from the network in RRC messaging.

In some embodiments of the method 600, the indication of the RA type is received from the network as a single bit in the DCI.

In some embodiments of the method 600, the DCI further comprises an indication of a number of the plurality of scheduled cells.

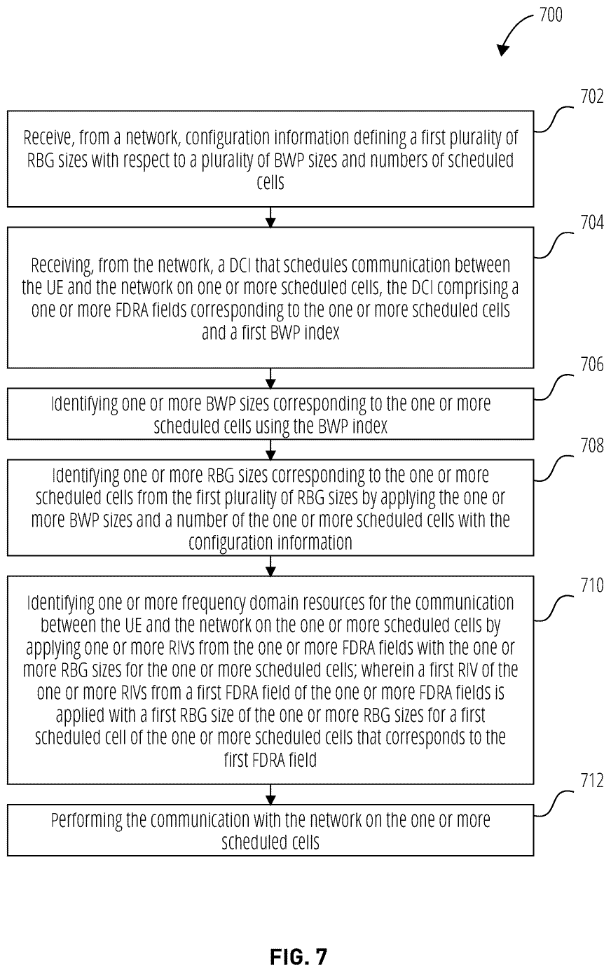

FIG. 7 illustrates a method 700 of a UE, according to embodiments herein. The method 700 includes receiving 702, from a network, configuration information defining a first plurality of RBG sizes with respect to a plurality of BWP sizes and numbers of scheduled cells.

The method 700 further includes receiving 704, from the network, a downlink control information (DCI) that schedules communication between the UE and the network on one or more scheduled cells, the DCI comprising a one or more frequency domain resource allocation (FDRA) fields corresponding to the one or more scheduled cells and a first BWP index.

The method 700 further includes identifying 706 one or more BWP sizes corresponding to the one or more scheduled cells using the BWP index.

The method 700 further includes identifying 708 one or more RBG sizes corresponding to the one or more scheduled cells from the first plurality of RBG sizes by applying the one or more BWP sizes and a number of the one or more scheduled cells with the configuration information.

The method 700 further includes identifying 710 one or more frequency domain resources for the communication between the UE and the network on the one or more scheduled cells by applying one or more RIVs from the one or more FDRA fields with the one or more RBG sizes for the one or more scheduled cells; wherein a first RIV of the one or more RIVs from a first FDRA field of the one or more FDRA fields is applied with a first RBG size of the one or more RBG sizes for a first scheduled cell of the one or more scheduled cells that corresponds to the first FDRA field.

The method 700 further includes performing 712 the communication with the network on the one or more scheduled cells.

In some embodiments of the method 700, the configuration information further defines a second plurality of RBG sizes with respect to the plurality of BWP sizes and the numbers of scheduled cells, and the method 700 further includes selecting, from among the first plurality of RBG sizes and the second plurality of RBG sizes, to use the first plurality of RBG sizes to identify the one or more RBG sizes. In some such embodiments, the selecting to use the first plurality of RBG sizes to identify the one or more RBG sizes is based on one of: an RRC message; and a type of the DCI.

In some embodiments of the method 700, the DCI further comprises an indication of the number of the one or more scheduled cells.

In some embodiments of the method 700, the configuration information defines that a first subset of the first plurality of RBG sizes applies when a single cell is scheduled by the DCI and that a second subset of the first plurality of RBG sizes applies when any more than one cell is scheduled by the DCI.

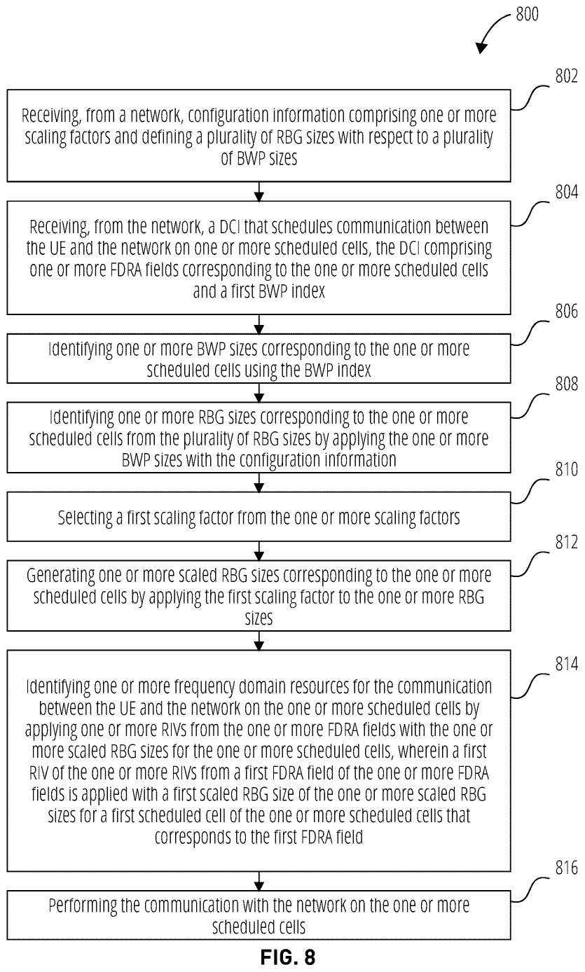

FIG. 8 illustrates a method 800 of a UE, according to embodiments herein. The method 800 includes receiving 802, from a network, configuration information comprising one or more scaling factors and defining a plurality of RBG sizes with respect to a plurality of BWP sizes.

The method 800 further includes receiving 804, from the network, a DCI that schedules communication between the UE and the network on one or more scheduled cells, the DCI comprising one or more FDRA fields corresponding to the one or more scheduled cells and a first BWP index.

The method 800 further includes identifying 806 one or more BWP sizes corresponding to the one or more scheduled cells using the BWP index.

The method 800 further includes identifying 808 one or more RBG sizes corresponding to the one or more scheduled cells from the plurality of RBG sizes by applying the one or more BWP sizes with the configuration information.

The method 800 further includes selecting 810 a first scaling factor from the one or more scaling factors.

The method 800 further includes generating 812 one or more scaled RBG sizes corresponding to the one or more scheduled cells by applying the first scaling factor to the one or more RBG sizes.

The method 800 further includes identifying 814 one or more frequency domain resources for the communication between the UE and the network on the one or more scheduled cells by applying one or more RIVs from the one or more FDRA fields with the one or more scaled RBG sizes for the one or more scheduled cells, wherein a first RIV of the one or more RIVs from a first FDRA field of the one or more FDRA fields is applied with a first scaled RBG size of the one or more scaled RBG sizes for a first scheduled cell of the one or more scheduled cells that corresponds to the first FDRA field.

The method 800 further includes performing 816 the communication with the network on the one or more scheduled cells.

In some embodiments of the method 800, the selecting the first scaling factor from the one or more scaling factors includes identifying that the one or more scheduled cells belong to a configured cell set that corresponds to the first scaling factor.

In some embodiments of the method 800, the one or more scaling factors comprises a plurality of scaling factors, and the selecting the first scaling factor from the one or more scaling factors is based on a number of the one or more scheduled cells.

In some embodiments of the method 800, the DCI further comprises an indication of a number of the plurality of scheduled cells.

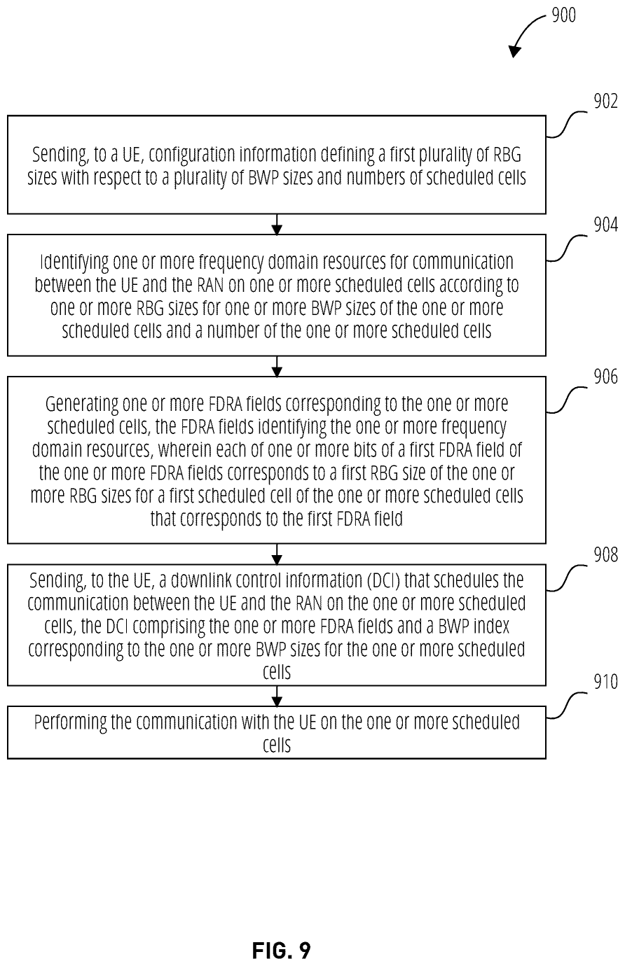

FIG. 9 illustrates a method 900 of a RAN, according to embodiments herein. The method 900 includes sending 902, to a UE, configuration information defining a first plurality of RBG sizes with respect to a plurality of BWP sizes and numbers of scheduled cells.

The method 900 further includes identifying 904 one or more frequency domain resources for communication between the UE and the RAN on one or more scheduled cells according to one or more RBG sizes for one or more BWP sizes of the one or more scheduled cells and a number of the one or more scheduled cells.

The method 900 further includes generating 906 one or more FDRA fields corresponding to the one or more scheduled cells, the FDRA fields identifying the one or more frequency domain resources, wherein each of one or more bits of a first FDRA field of the one or more FDRA fields corresponds to a first RBG size of the one or more RBG sizes for a first scheduled cell of the one or more scheduled cells that corresponds to the first FDRA field.

The method 900 further includes sending 908, to the UE, a DCI that schedules the communication between the UE and the RAN on the one or more scheduled cells, the DCI comprising the one or more FDRA fields and a BWP index corresponding to the one or more BWP sizes for the one or more scheduled cells.

The method 900 further includes performing 910 the communication with the UE on the one or more scheduled cells.

In some embodiments of the method 900, the configuration information further defines a second plurality of RBG sizes with respect to the plurality of BWP sizes and the numbers of scheduled cells. In some such embodiments, the method 900 further includes providing, to the UE, an indication to use the first plurality of RBG sizes to determine the one or more RBG sizes, wherein the indication comprises one of: data of an RRC message; and a type of the DCI.

In some embodiments of the method 900, the configuration information defines that a first subset of the first plurality of RBG sizes applies when a single cell is scheduled by the DCI and that a second subset of the first plurality of RBG sizes applies when any more than one cell is scheduled by the DCI.

In some embodiments of the method 900, the DCI further comprises an indication of the number of the one or more scheduled cells.

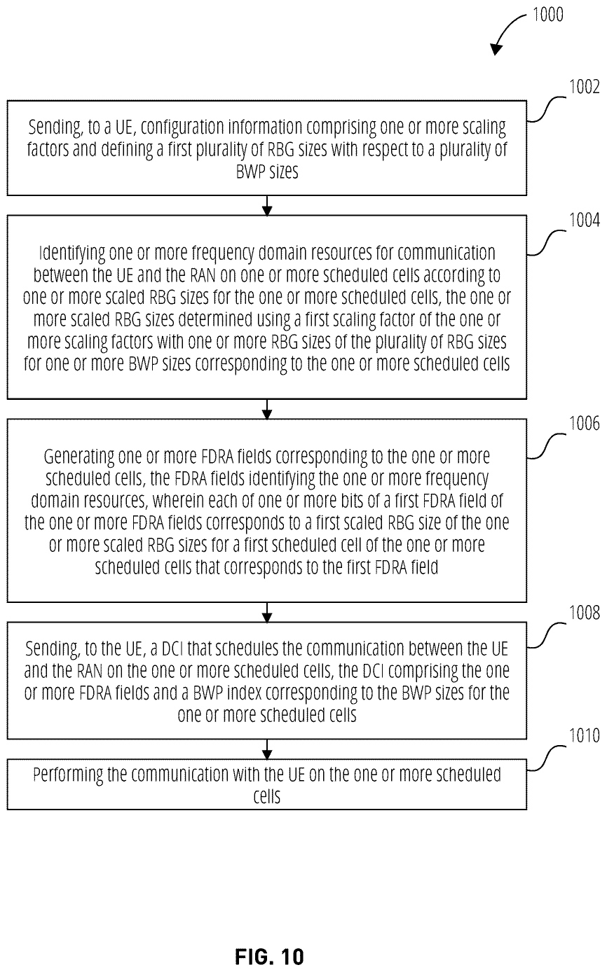

FIG. 10 illustrates a method 1000 of a RAN, according to embodiments herein. The method 1000 includes sending 1002 to a UE, configuration information comprising one or more scaling factors and defining a first plurality of RBG sizes with respect to a plurality of BWP sizes.

The method 1000 further includes identifying 1004 one or more frequency domain resources for communication between the UE and the RAN on one or more scheduled cells according to one or more scaled RBG sizes for the one or more scheduled cells, the one or more scaled RBG sizes determined using a first scaling factor of the one or more scaling factors with one or more RBG sizes of the plurality of RBG sizes for one or more BWP sizes corresponding to the one or more scheduled cells.

The method 1000 further includes generating 1006 one or more FDRA fields corresponding to the one or more scheduled cells, the FDRA fields identifying the one or more frequency domain resources, wherein each of one or more bits of a first FDRA field of the one or more FDRA fields corresponds to a first scaled RBG size of the one or more scaled RBG sizes for a first scheduled cell of the one or more scheduled cells that corresponds to the first FDRA field.

The method 1000 further includes sending 1008, to the UE, a downlink control information (DCI) that schedules the communication between the UE and the RAN on the one or more scheduled cells, the DCI comprising the one or more FDRA fields and a BWP index corresponding to the BWP sizes for the one or more scheduled cells.

The method 1000 further includes performing 1010 the communication with the UE on the one or more scheduled cells.

In some embodiments, the method 1000 further includes indicating, to the UE, that the one or more scaling factors correspond to a configured cell set comprising the one or more scheduled cells.

In some embodiments of the method 1000, the DCI further comprises an indication of a number of the one or more scheduled cells.

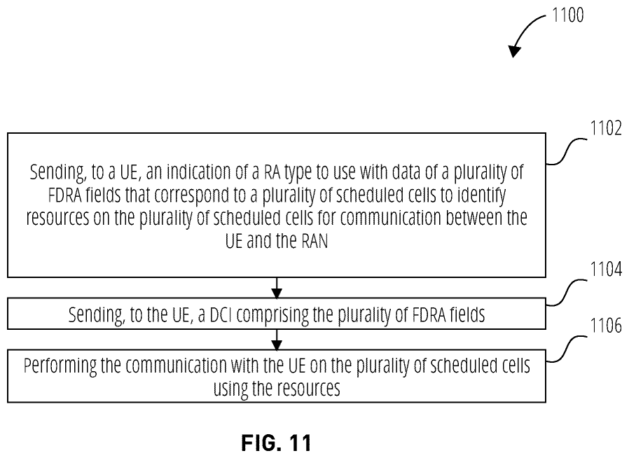

FIG. 11 illustrates a method 1100 of a RAN, according to embodiments herein. The method 1100 includes sending 1102, to a UE, an indication of an RA type to use with data of a plurality of FDRA fields that correspond to a plurality of scheduled cells to identify resources on the plurality of scheduled cells for communication between the UE and the RAN.

The method 1100 further includes sending 1104, to the UE, a DCI comprising the plurality of FDRA fields.

The method 1100 further includes performing 1106 the communication with the UE on the plurality of scheduled cells using the resources.

In some embodiments, of the method 1100, the indication of the RA type is sent to the UE in RRC messaging.

In some embodiments, of the method 1100, the indication of the RA type is sent to the UE as a single bit in the DCI.

In some embodiments, of the method 1100, the DCI further comprises an indication of a number of the plurality of scheduled cells.

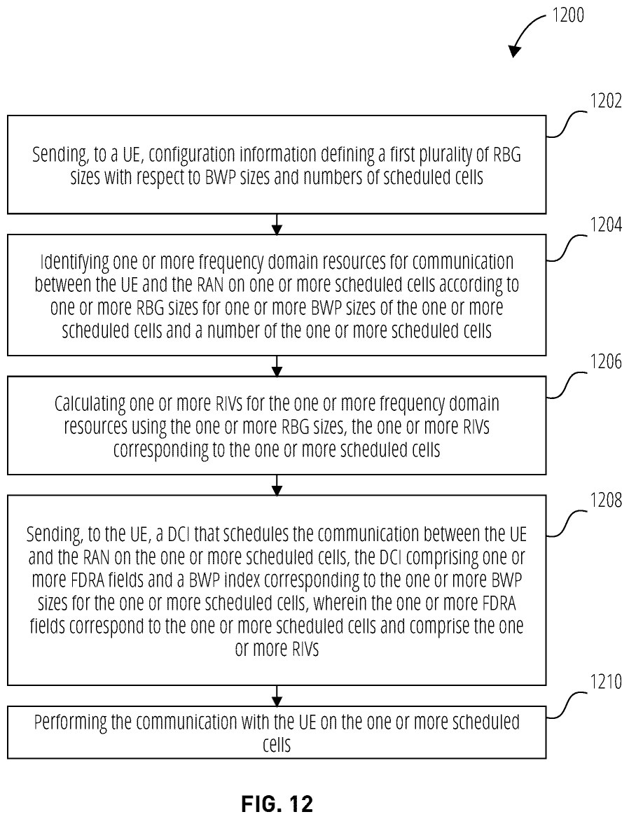

FIG. 12 illustrates a method 1200 of a RAN, according to embodiments herein. The method 1200 includes sending 1202, to a UE, configuration information defining a first plurality of RBG sizes with respect to BWP sizes and numbers of scheduled cells.

The method 1200 further includes identifying 1204 one or more frequency domain resources for communication between the UE and the RAN on one or more scheduled cells according to one or more RBG sizes for one or more BWP sizes of the one or more scheduled cells and a number of the one or more scheduled cells.

The method 1200 further includes calculating 1206 one or more RIVs for the one or more frequency domain resources using the one or more RBG sizes, the one or more RIVs corresponding to the one or more scheduled cells.

The method 1200 further includes sending 1208, to the UE, a DCI that schedules the communication between the UE and the RAN on the one or more scheduled cells, the DCI comprising one or more FDRA fields and a BWP index corresponding to the one or more BWP sizes for the one or more scheduled cells, wherein the one or more FDRA fields correspond to the one or more scheduled cells and comprise the one or more RIVs.

The method 1200 further includes performing 1210 the communication with the UE on the one or more scheduled cells.

In some embodiments of the method 1200, the configuration information further defines a second plurality of RBG sizes with respect to the BWP sizes and the numbers of scheduled cells. In some such embodiments, the method 1200 further includes providing, to the UE, an indication to use the first plurality of RBG sizes to identify the one or more RBG sizes, wherein the indication comprises one of: data of an RRC message; and a type of the DCI.

In some embodiments of the method 1200, the configuration information defines that a first subset of the first plurality of RBG sizes applies when a single cell is scheduled by the DCI and that a second subset of the first plurality of RBG sizes applies when any more than one cell is scheduled by the DCI.

In some embodiments of the method 1200, the DCI further comprises an indication of the number of the one or more scheduled cells.

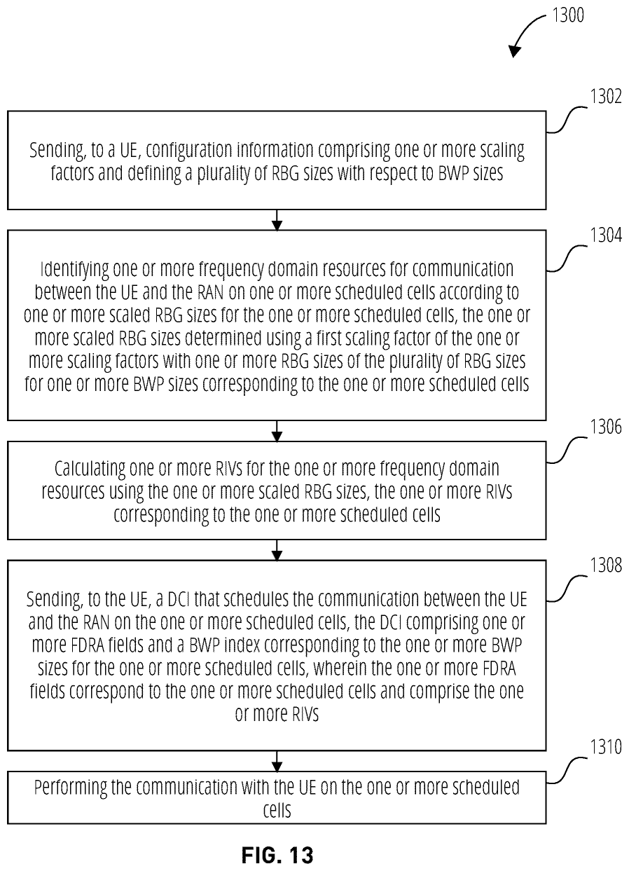

FIG. 13 illustrates a method 1300 of a RAN, according to embodiments herein. The method 1300 includes sending 1302, to a UE, configuration information comprising one or more scaling factors and defining a plurality of RBG sizes with respect to BWP sizes.

The method 1300 further includes identifying 1304 one or more frequency domain resources for communication between the UE and the RAN on one or more scheduled cells according to one or more scaled RBG sizes for the one or more scheduled cells, the one or more scaled RBG sizes determined using a first scaling factor of the one or more scaling factors with one or more RBG sizes of the plurality of RBG sizes for one or more BWP sizes corresponding to the one or more scheduled cells.

The method 1300 further includes calculating 1306 one or more RIVs for the one or more frequency domain resources using the one or more scaled RBG sizes, the one or more RIVs corresponding to the one or more scheduled cells.

The method 1300 further includes sending 1308, to the UE, a DCI that schedules the communication between the UE and the RAN on the one or more scheduled cells, the DCI comprising one or more FDRA fields and a BWP index corresponding to the one or more BWP sizes for the one or more scheduled cells, wherein the one or more FDRA fields correspond to the one or more scheduled cells and comprise the one or more RIVs.

The method 1300 further includes performing 1310 the communication with the UE on the one or more scheduled cells.

In some embodiments, the method 1300 further includes indicating, to the UE, that the one or more scaling factors correspond to a configured cell set comprising the one or more scheduled cells.

In some embodiments of the method 1300, the DCI further comprises an indication of a number of the one or more scheduled cells.

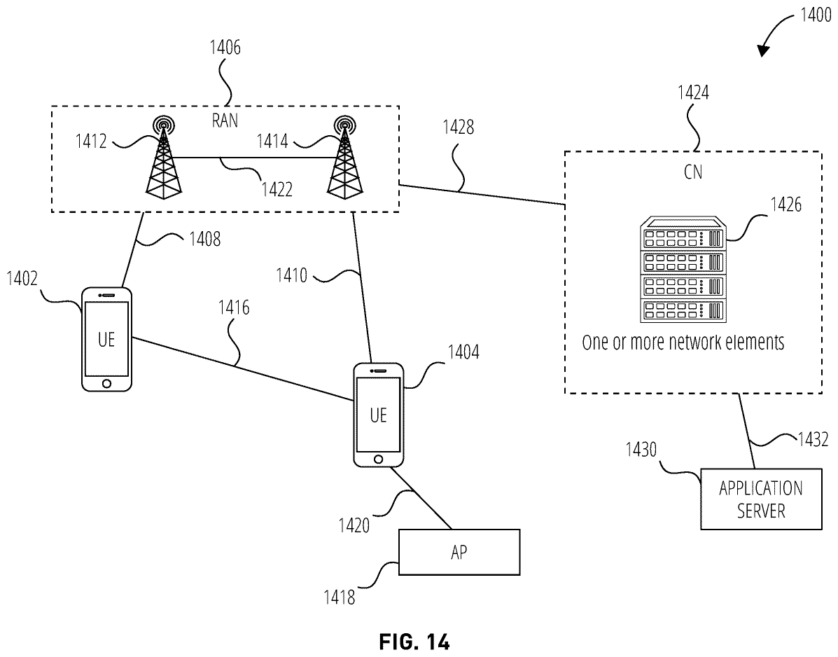

FIG. 14 illustrates an example architecture of a wireless communication system 1400, according to embodiments disclosed herein. The following description is provided for an example wireless communication system 1400 that operates in conjunction with the LTE system standards and/or 5G or NR system standards as provided by 3GPP technical specifications.

As shown by FIG. 14, the wireless communication system 1400 includes UE 1402 and UE 1404 (although any number of UEs may be used). In this example, the UE 1402 and the UE 1404 are illustrated as smartphones (e.g., handheld touchscreen mobile computing devices connectable to one or more cellular networks), but may also comprise any mobile or non-mobile computing device configured for wireless communication.

The UE 1402 and UE 1404 may be configured to communicatively couple with a RAN 1406. In embodiments, the RAN 1406 may be NG-RAN, E-UTRAN, etc. The UE 1402 and UE 1404 utilize connections (or channels) (shown as connection 1408 and connection 1410, respectively) with the RAN 1406, each of which comprises a physical communications interface. The RAN 1406 can include one or more base stations (such as base station 1412 and base station 1414) that enable the connection 1408 and connection 1410.

In this example, the connection 1408 and connection 1410 are air interfaces to enable such communicative coupling, and may be consistent with RAT(s) used by the RAN 1406, such as, for example, an LTE and/or NR.

In some embodiments, the UE 1402 and UE 1404 may also directly exchange communication data via a sidelink interface 1416. The UE 1404 is shown to be configured to access an access point (shown as AP 1418) via connection 1420. By way of example, the connection 1420 can comprise a local wireless connection, such as a connection consistent with any IEEE 802.11 protocol, wherein the AP 1418 may comprise a Wi-Fi® router. In this example, the AP 1418 may be connected to another network (for example, the Internet) without going through a CN 1424.

In embodiments, the UE 1402 and UE 1404 can be configured to communicate using orthogonal frequency division multiplexing (OFDM) communication signals with each other or with the base station 1412 and/or the base station 1414 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 1412 or base station 1414 may be implemented as one or more software entities running on server computers as part of a virtual network. In addition, or in other embodiments, the base station 1412 or base station 1414 may be configured to communicate with one another via interface 1422. In embodiments where the wireless communication system 1400 is an LTE system (e.g., when the CN 1424 is an EPC), the interface 1422 may be an X2 interface. The X2 interface may be defined between two or more base stations (e.g., two or more eNBs and the like) that connect to an EPC, and/or between two eNBs connecting to the EPC. In embodiments where the wireless communication system 1400 is an NR system (e.g., when CN 1424 is a 5GC), the interface 1422 may be an Xn interface. The Xn interface is defined between two or more base stations (e.g., two or more gNBs and the like) that connect to 5GC, between a base station 1412 (e.g., a gNB) connecting to 5GC and an eNB, and/or between two eNBs connecting to 5GC (e.g., CN 1424).

The RAN 1406 is shown to be communicatively coupled to the CN 1424. The CN 1424 may comprise one or more network elements 1426, which are configured to offer various data and telecommunications services to customers/subscribers (e.g., users of UE 1402 and UE 1404) who are connected to the CN 1424 via the RAN 1406. The components of the CN 1424 may be implemented in one physical device or separate physical devices including components to read and execute instructions from a machine-readable or computer-readable medium (e.g., a non-transitory machine-readable storage medium).

In embodiments, the CN 1424 may be an EPC, and the RAN 1406 may be connected with the CN 1424 via an S1 interface 1428. In embodiments, the S1 interface 1428 may be split into two parts, an S1 user plane (S1-U) interface, which carries traffic data between the base station 1412 or base station 1414 and a serving gateway (S-GW), and the S1-MME interface, which is a signaling interface between the base station 1412 or base station 1414 and mobility management entities (MMEs).

In embodiments, the CN 1424 may be a 5GC, and the RAN 1406 may be connected with the CN 1424 via an NG interface 1428. In embodiments, the NG interface 1428 may be split into two parts, an NG user plane (NG-U) interface, which carries traffic data between the base station 1412 or base station 1414 and a user plane function (UPF), and the S1 control plane (NG-C) interface, which is a signaling interface between the base station 1412 or base station 1414 and access and mobility management functions (AMFs).

Generally, an application server 1430 may be an element offering applications that use internet protocol (IP) bearer resources with the CN 1424 (e.g., packet switched data services). The application server 1430 can also be configured to support one or more communication services (e.g., VoIP sessions, group communication sessions, etc.) for the UE 1402 and UE 1404 via the CN 1424. The application server 1430 may communicate with the CN 1424 through an IP communications interface 1432.

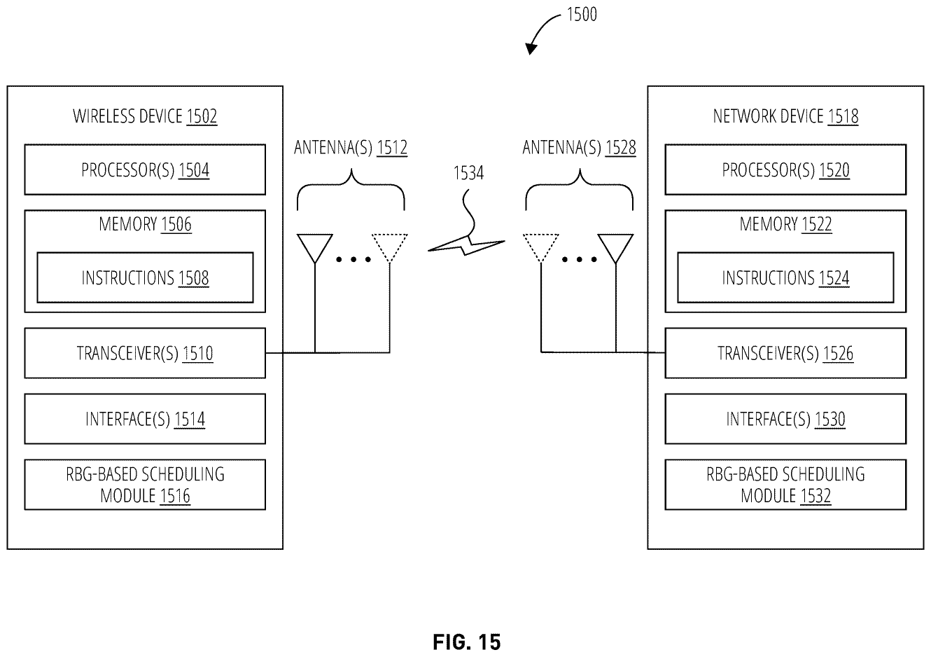

FIG. 15 illustrates a system 1500 for performing signaling 1534 between a wireless device 1502 and a network device 1518, according to embodiments disclosed herein. The system 1500 may be a portion of a wireless communications system as herein described. The wireless device 1502 may be, for example, a UE of a wireless communication system. The network device 1518 may be, for example, a base station (e.g., an eNB or a gNB) of a wireless communication system.

The wireless device 1502 may include one or more processor(s) 1504. The processor(s) 1504 may execute instructions such that various operations of the wireless device 1502 are performed, as described herein. The processor(s) 1504 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 1502 may include a memory 1506. The memory 1506 may be a non-transitory computer-readable storage medium that stores instructions 1508 (which may include, for example, the instructions being executed by the processor(s) 1504). The instructions 1508 may also be referred to as program code or a computer program. The memory 1506 may also store data used by, and results computed by, the processor(s) 1504.

The wireless device 1502 may include one or more transceiver(s) 1510 that may include radio frequency (RF) transmitter and/or receiver circuitry that use the antenna(s) 1512 of the wireless device 1502 to facilitate signaling (e.g., the signaling 1534) to and/or from the wireless device 1502 with other devices (e.g., the network device 1518) according to corresponding RATs.

The wireless device 1502 may include one or more antenna(s) 1512 (e.g., one, two, four, or more). For embodiments with multiple antenna(s) 1512, the wireless device 1502 may leverage the spatial diversity of such multiple antenna(s) 1512 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 1502 may be accomplished according to precoding (or digital beamforming) that is applied at the wireless device 1502 that multiplexes the data streams across the antenna(s) 1512 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 1502 may implement analog beamforming techniques, whereby phases of the signals sent by the antenna(s) 1512 are relatively adjusted such that the (joint) transmission of the antenna(s) 1512 can be directed (this is sometimes referred to as beam steering).

The wireless device 1502 may include one or more interface(s) 1514. The interface(s) 1514 may be used to provide input to or output from the wireless device 1502. For example, a wireless device 1502 that is a UE may include interface(s) 1514 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 1510/antenna(s) 1512 already described) that allow for communication between the UE and other devices and may operate according to known protocols (e.g., Wi-Fi®, Bluetooth®, and the like).

The wireless device 1502 may include an RBG-based scheduling module 1516. The RBG-based scheduling module 1516 may be implemented via hardware, software, or combinations thereof. For example, the RBG-based scheduling module 1516 may be implemented as a processor, circuit, and/or instructions 1508 stored in the memory 1506 and executed by the processor(s) 1504. In some examples, the RBG-based scheduling module 1516 may be integrated within the processor(s) 1504 and/or the transceiver(s) 1510. For example, the RBG-based scheduling module 1516 may be implemented by a combination of software components (e.g., executed by a DSP or a general processor) and hardware components (e.g., logic gates and circuitry) within the processor(s) 1504 or the transceiver(s) 1510.

The RBG-based scheduling module 1516 may be used for various aspects of the present disclosure, for example, aspects of FIG. 1 through FIG. 13. The RBG-based scheduling module 1516 may be configured to, for example, determine an applicable RBG size based on a BWP size for a cell and/or a number of scheduled cells, as discussed herein. Further, the RBG-based scheduling module 1516 may be configured to apply a scaling factor with an identified RBG group size, as discussed herein. Further, the RBG-based scheduling module 1516 may be configured to use a determined RBG group size in an RA type 0 or an RA type 1 interpretation of one or more FDRA fields in DCI, as discussed herein.

The network device 1518 may include one or more processor(s) 1520. The processor(s) 1520 may execute instructions such that various operations of the network device 1518 are performed, as described herein. The processor(s) 1520 may include one or more baseband processors implemented using, for example, a CPU, a DSP, an ASIC, a controller, an FPGA device, another hardware device, a firmware device, or any combination thereof configured to perform the operations described herein.

The network device 1518 may include a memory 1522. The memory 1522 may be a non-transitory computer-readable storage medium that stores instructions 1524 (which may include, for example, the instructions being executed by the processor(s) 1520). The instructions 1524 may also be referred to as program code or a computer program. The memory 1522 may also store data used by, and results computed by, the processor(s) 1520.

The network device 1518 may include one or more transceiver(s) 1526 that may include RF transmitter and/or receiver circuitry that use the antenna(s) 1528 of the network device 1518 to facilitate signaling (e.g., the signaling 1534) to and/or from the network device 1518 with other devices (e.g., the wireless device 1502) according to corresponding RATs.

The network device 1518 may include one or more antenna(s) 1528 (e.g., one, two, four, or more). In embodiments having multiple antenna(s) 1528, the network device 1518 may perform MIMO, digital beamforming, analog beamforming, beam steering, etc., as has been described.

The network device 1518 may include one or more interface(s) 1530. The interface(s) 1530 may be used to provide input to or output from the network device 1518. For example, a network device 1518 that is a base station may include interface(s) 1530 made up of transmitters, receivers, and other circuitry (e.g., other than the transceiver(s) 1526/antenna(s) 1528 already described) that enables the base station to communicate with other equipment in a core network, and/or that enables the base station to communicate with external networks, computers, databases, and the like for purposes of operations, administration, and maintenance of the base station or other equipment operably connected thereto.

The network device 1518 may include an RBG-based scheduling module 1532. The RBG-based scheduling module 1532 may be implemented via hardware, software, or combinations thereof. For example, the RBG-based scheduling module 1532 may be implemented as a processor, circuit, and/or instructions 1524 stored in the memory 1522 and executed by the processor(s) 1520. In some examples, the RBG-based scheduling module 1532 may be integrated within the processor(s) 1520 and/or the transceiver(s) 1526. For example, the RBG-based scheduling module 1532 may be implemented by a combination of software components (e.g., executed by a DSP or a general processor) and hardware components (e.g., logic gates and circuitry) within the processor(s) 1520 or the transceiver(s) 1526.

The RBG-based scheduling module 1532 may be used for various aspects of the present disclosure, for example, aspects of FIG. 1 through FIG. 13. The RBG-based scheduling module 1532 may be configured to, for example, generate configuration information for determining an applicable RBG size based on a BWP size for a cell and/or a number of scheduled cells, as discussed herein. Further, the RBG-based scheduling module 1516 may be configured to configure one or more scaling factors intended for use with an identified RBG group size, as discussed herein. Further, the RBG-based scheduling module 1516 may be configured to use a determined RBG group size in an RA type 0 or an RA type 1 generation of one or more RDNA fields in DCI, as discussed herein.

Embodiments contemplated herein include an apparatus comprising means to perform one or more elements of any of the method 400, the method 500, the method 600, the method 700, and the method 800. This apparatus may be, for example, an apparatus of a UE (such as a wireless device 1502 that is a UE, as described herein).

Embodiments contemplated herein include one or more non-transitory computer-readable media comprising instructions to cause an electronic device, upon execution of the instructions by one or more processors of the electronic device, to perform one or more elements of any of the method 400, the method 500, the method 600, the method 700, and the method 800. This non-transitory computer-readable media may be, for example, a memory of a UE (such as a memory 1506 of a wireless device 1502 that is a UE, as described herein).

Embodiments contemplated herein include an apparatus comprising logic, modules, or circuitry to perform one or more elements of any of the method 400, the method 500, the method 600, the method 700, and the method 800. This apparatus may be, for example, an apparatus of a UE (such as a wireless device 1502 that is a UE, as described herein).

Embodiments contemplated herein include an apparatus comprising: one or more processors and one or more computer-readable media comprising instructions that, when executed by the one or more processors, cause the one or more processors to perform one or more elements of any of the method 400, the method 500, the method 600, the method 700, and the method 800. This apparatus may be, for example, an apparatus of a UE (such as a wireless device 1502 that is a UE, as described herein).

Embodiments contemplated herein include a signal as described in or related to one or more elements of any of the method 400, the method 500, the method 600, the method 700, and the method 800.

Embodiments contemplated herein include a computer program or computer program product comprising instructions, wherein execution of the program by a processor is to cause the processor to carry out one or more elements of any of the method 400, the method 500, the method 600, the method 700, and the method 800. The processor may be a processor of a UE (such as a processor(s) 1504 of a wireless device 1502 that is a UE, as described herein). These instructions may be, for example, located in the processor and/or on a memory of the UE (such as a memory 1506 of a wireless device 1502 that is a UE, as described herein).

Embodiments contemplated herein include an apparatus comprising means to perform one or more elements of any of the method 900, the method 1000, the method 1100, the method 1200, and the method 1300. This apparatus may be, for example, an apparatus of a base station (such as a network device 1518 that is a base station, as described herein).

Embodiments contemplated herein include one or more non-transitory computer-readable media comprising instructions to cause an electronic device, upon execution of the instructions by one or more processors of the electronic device, to perform one or more elements of any of the method 900, the method 1000, the method 1100, the method 1200, and the method 1300. This non-transitory computer-readable media may be, for example, a memory of a base station (such as a memory 1522 of a network device 1518 that is a base station, as described herein).

Embodiments contemplated herein include an apparatus comprising logic, modules, or circuitry to perform one or more elements of any of the method 900, the method 1000, the method 1100, the method 1200, and the method 1300. This apparatus may be, for example, an apparatus of a base station (such as a network device 1518 that is a base station, as described herein).

Embodiments contemplated herein include an apparatus comprising: one or more processors and one or more computer-readable media comprising instructions that, when executed by the one or more processors, cause the one or more processors to perform one or more elements of any of the method 900, the method 1000, the method 1100, the method 1200, and the method 1300. This apparatus may be, for example, an apparatus of a base station (such as a network device 1518 that is a base station, as described herein).

Embodiments contemplated herein include a signal as described in or related to one or more elements of any of the method 900, the method 1000, the method 1100, the method 1200, and the method 1300.

Embodiments contemplated herein include a computer program or computer program product comprising instructions, wherein execution of the program by a processing element is to cause the processing element to carry out one or more elements of any of the method 900, the method 1000, the method 1100, the method 1200, and the method 1300. The processor may be a processor of a base station (such as a processor(s) 1520 of a network device 1518 that is a base station, as described herein). These instructions may be, for example, located in the processor and/or on a memory of the base station (such as a memory 1522 of a network device 1518 that is a base station, as described herein).

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1-14. (canceled)

15. A method of a user equipment (UE), comprising:
receiving, from a network, configuration information defining a first plurality of resource block group (RBG) sizes with respect to a plurality of bandwidth part (BWP) sizes and numbers of scheduled cells;
receiving, from the network, a downlink control information (DCI) that schedules communication between the UE and the network on one or more scheduled cells, the DCI comprising a one or more frequency domain resource allocation (FDRA) fields corresponding to the one or more scheduled cells and a first BWP index;
identifying one or more BWP sizes corresponding to the one or more scheduled cells using the BWP index;
identifying one or more RBG sizes corresponding to the one or more scheduled cells from the first plurality of RBG sizes by applying the one or more BWP sizes and a number of the one or more scheduled cells with the configuration information;
identifying one or more frequency domain resources for the communication between the UE and the network on the one or more scheduled cells by applying one or more resource indicator values (RIVs) from the one or more FDRA fields with the one or more RBG sizes for the one or more scheduled cells; wherein a first RIV of the one or more RIVs from a first FDRA field of the one or more FDRA fields is applied with a first RBG size of the one or more RBG sizes for a first scheduled cell of the one or more scheduled cells that corresponds to the first FDRA field; and
performing the communication with the network on the one or more scheduled cells.

16. The method of claim 15, wherein the configuration information further defines a second plurality of RBG sizes with respect to the plurality of BWP sizes and the numbers of scheduled cells, and further comprising selecting, from among the first plurality of RBG sizes and the second plurality of RBG sizes, to use the first plurality of RBG sizes to identify the one or more RBG sizes.

17. The method of claim 16, wherein the selecting to use the first plurality of RBG sizes to identify the one or more RBG sizes is based on one of:
a radio resource control (RRC) message; and
a type of the DCI.

18. The method of claim 15, wherein the DCI further comprises an indication of the number of the one or more scheduled cells.

19. The method of claim 15, wherein the configuration information defines that a first subset of the first plurality of RBG sizes applies when a single cell is scheduled by the DCI and that a second subset of the first plurality of RBG sizes applies when any more than one cell is scheduled by the DCI.

20. A method of a user equipment (UE), comprising:
receiving, from a network, configuration information comprising one or more scaling factors and defining a plurality of resource block group (RBG) sizes with respect to a plurality of bandwidth part (BWP) sizes;
receiving, from the network, a downlink control information (DCI) that schedules communication between the UE and the network on one or more scheduled cells, the DCI comprising one or more frequency domain resource allocation (FDRA) fields corresponding to the one or more scheduled cells and a first BWP index;
identifying one or more BWP sizes corresponding to the one or more scheduled cells using the BWP index;
identifying one or more RBG sizes corresponding to the one or more scheduled cells from the plurality of RBG sizes by applying the one or more BWP sizes with the configuration information;
selecting a first scaling factor from the one or more scaling factors;
generating one or more scaled RBG sizes corresponding to the one or more scheduled cells by applying the first scaling factor to the one or more RBG sizes;
identifying one or more frequency domain resources for the communication between the UE and the network on the one or more scheduled cells by applying one or more resource indicator values (RIVs) from the one or more FDRA fields with the one or more scaled RBG sizes for the one or more scheduled cells, wherein a first RIV of the one or more RIVs from a first FDRA field of the one or more FDRA fields is applied with a first scaled RBG size of the one or more scaled RBG sizes for a first scheduled cell of the one or more scheduled cells that corresponds to the first FDRA field; and
performing the communication with the network on the one or more scheduled cells.

21. The method of claim 20, wherein the selecting the first scaling factor from the one or more scaling factors comprises identifying that the one or more scheduled cells belong to a configured cell set that corresponds to the first scaling factor.

22. The method of claim 20, further comprising determining that a number of the one or more scheduled cells is greater than one, and wherein the selecting the first scaling factor from the one or more scaling factors occurs in response to the determining that the number of the one or more scheduled cells is greater than one.

23. The method of claim 20, wherein the one or more scaling factors comprises a plurality of scaling factors, and wherein the selecting the first scaling factor from the one or more scaling factors is based on a number of the one or more scheduled cells.

24. The method of claim 20, wherein the DCI further comprises an indication of a number of the plurality of scheduled cells.

25-36. (canceled)

37. A method of a radio access network (RAN), comprising:
sending, to a user equipment (UE), configuration information defining a first plurality of resource block group (RBG) sizes with respect to bandwidth part (BWP) sizes and numbers of scheduled cells;
identifying one or more frequency domain resources for communication between the UE and the RAN on one or more scheduled cells according to one or more RBG sizes for one or more BWP sizes of the one or more scheduled cells and a number of the one or more scheduled cells;
calculating one or more resource indicator values (RIVs) for the one or more frequency domain resources using the one or more RBG sizes, the one or more RIVs corresponding to the one or more scheduled cells;
sending, to the UE, a downlink control information (DCI) that schedules the communication between the UE and the RAN on the one or more scheduled cells, the DCI comprising one or more frequency domain resource allocation (FDRA) fields and a BWP index corresponding to the one or more BWP sizes for the one or more scheduled cells, wherein the one or more FDRA fields correspond to the one or more scheduled cells and comprise the one or more RIVs; and
performing the communication with the UE on the one or more scheduled cells.

38. The method of claim 37, wherein the configuration information further defines a second plurality of RBG sizes with respect to the BWP sizes and the numbers of scheduled cells.

39. The method of claim 38, further comprising providing, to the UE, an indication to use the first plurality of RBG sizes to identify the one or more RBG sizes, wherein the indication comprises one of:
data of a radio resource control (RRC) message; and
a type of the DCI.

40. The method of claim 37, wherein the configuration information defines that a first subset of the first plurality of RBG sizes applies when a single cell is scheduled by the DCI and that a second subset of the first plurality of RBG sizes applies when any more than one cell is scheduled by the DCI.

41. The method of claim 37, wherein the DCI further comprises an indication of the number of the one or more scheduled cells.

42-48. (canceled)
